(19) United States
(12) Patent Application Publication
(10) Pub. No.: US 2023/0115026 A1
(43) Pub. Date: Apr. 13, 2023

(54) FLEXIBLE ROTARY CUTTING DEVICE AND METHOD

(71) Applicant: Richard Nevels, Sulphur Springs, AR (US)

(72) Inventor: Richard Nevels, Sulphur Springs, AR (US)

(21) Appl. No.: 18/072,046

(22) Filed: Nov. 30, 2022

Related U.S. Application Data
(63) Continuation-in-part of application No. 16/670,451, filed on Oct. 31, 2019.
Application No. 16/670,451 is a continuation-in-part of application No. 15/872,941, filed on Jan. 16, 2018, now abandoned.
(60) Provisional application No. 62/446,221, filed on Jan. 13, 2017.

(51) Int. Cl. A01D 34/416

(52) U.S. Cl. CPC A01D 34/4166; A01D 2101/00

(57) ABSTRACT

A flexible rotary cutting device useful for attaching to a rotary drive configured to trim vegetation, particularly a lawn mower. The flexible rotary cutting device includes a cutting head, an attachment mechanism, at least one cutting-filament retention mechanisms, and at least one cutting-filament. At least one cutting-filament may be releasably attached to the at least one cutting-filament retention mechanism. The at least one cutting-filament may be configured to sever vegetation as the cutting head is rotated, and may be positioned such that it is passed through the at least one filament-aperture, and between the first-filament engaging pawl and the second-filament engaging pawl, in such a way that the at least one cutting-filament is engaged and anchored by the first-plurality of teeth and the second-plurality of teeth, and extends radially from the outer flange of the cutting head.

### CROSS-REFERENCE TO RELATED APPLICATIONS

The present application a continuation-in-part of U.S. Pat. Application No. 16/670,451, Filed Oct. 31, 2019, now U.S. Pat. Application Pub. No. 2020/0060080 which is a continuation-in-part of U.S. Pat. Application No. 15/872,941 Filed Jan. 16, 2018, now U.S. Pat. Application Pub. No. 2018/0199507 which is related to and claims priority to U.S. Provisional Pat. Application Number 62/446,221 filed Jan. 13, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of cutting devices of existing art and more specifically relates to lawnmower blades.

### Related Art

Many homeowners use lawnmowers to cut grass. A lawn mower is a machine utilizing one or more revolving blades to cut a grass surface to an even height. The height of the cut grass is adjustable by the operator, typically by a single master lever, or by a lever or nut and bolt on each of the machine’s wheels. Lawn mowers may employ a single blade that rotates about a single vertical axis, or a cutting bar and multiple blade assembly that rotates about a single horizontal axis. Mowing with a standard fixed/solid blade on all types of terrain can cause damage to the blade and the housing. A fixed blade is sufficient when mowing level grass, however rocky or rough terrain can result in broken blades, projectile objects being thrown, injuries, and more. Replacing or repairing the blades and damage to the housing can be costly and time consuming. An efficient solution is needed.

U.S. Pat. No. 4,086,700 to Kiichi Inada relates to a cutting head for a mower. The described cutting head for a mower includes a cutter for a lawn mower having a rotating disc for mounting on a driving mechanism, the disc having a cavity therein and two openings at diametrically opposite points in the periphery of the disc and opening out of the disc from the cavity.

### SUMMARY OF THE INVENTION

In view of the foregoing disadvantages inherent in the known lawnmower blade art, the present disclosure provides a novel flexible rotary cutting device and method. The general purpose of the present disclosure, which will be described subsequently in greater detail, is to provide a flexible rotary cutting device efficient and effective for use.

A flexible rotary cutting device is disclosed herein. The flexible rotary cutting device is useful for attaching to a rotary drive configured to trim vegetation, particularly a lawn mower. The flexible rotary cutting device includes a cutting head, an attachment mechanism, at least one cutting-filament retention mechanisms, and at least one cutting-filament. The cutting head includes a disk, and outer flange affixed to the disk, a cover affixed to the outer flange, and a rotational axis passing through the center of the disk defining the axis of rotation of the flexible rotary cutting device. The outer flange may circumscribe an inner volume defined within the cutting head. An attachment mechanism is affixed to the cutting head, and serves to enable the cutting head to be releasably attached to the rotary drive. The at least one cutting-filament retention mechanism may include a first-fulcrum cylinder having a first-fulcrum axis affixed to the cutting head, such that the first-fulcrum axis is parallel but not concentric to the rotational axis. A second-fulcrum cylinder having a second-fulcrum axis may be likewise affixed to the cutting head, the second-fulcrum axis also being parallel but not concentric to the rotational axis. The at least one cutting-filament retention mechanism may further include a first-filament engaging pawl pivotably engaging the first-fulcrum cylinder having a first-plurality of teeth, and a second-filament engaging pawl pivotably engaging the second-fulcrum cylinder having a second-plurality of teeth. The second-filament engaging pawl may be positioned opposite the first-filament engaging pawl, such that it mirrors the first-filament engaging pawl. At least one filament-aperture may be disposed within the outer flange of the cutting head.

At least one cutting-filament may be releasably attached to the at least one cutting-filament retention mechanism. The at least one cutting-filament may be configured to sever vegetation as the cutting head is rotated, and may be positioned such that it is passed through the at least one filament-aperture, and between the first-filament engaging pawl and the second-filament engaging pawl, in such a way that the at least one cutting-filament is engaged and anchored by the first-plurality of teeth and the second-plurality of teeth, and extends radially from the outer flange of the cutting head.

According to another embodiment, a method of trimming vegetation is also disclosed herein. The method of trimming vegetation includes firstly, providing the flexible rotary cutting device as described; secondly, coupling the attachment mechanism to the rotary drive; thirdly, inserting the at least one cutting-filament into the at least one cutting-filament retention mechanism; fourthly, rotating the rotary drive in order to rotate the cutting device in tandem with the rotary drive; fifthly, severing vegetation with the at least one cutting-filament as the at least one cutting-filament makes contact with vegetation; and sixthly and optionally, re-inserting the at least one cutting-filament into the at least one cutting-filament retention mechanism as the at least one cutting-filament is consumed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a flexible rotary cutting device and method, constructed and operative according to the teachings of the present disclosure.

FIG. 1 is a perspective view of the flexible rotary cutting device during an ‘in-use’ condition, according to an embodiment of the disclosure.

FIG. 2 is a perspective view of the flexible rotary cutting device of FIG. 1, according to an embodiment of the present disclosure.

FIG. 3 is a perspective view of the flexible rotary cutting device of FIG. 1, according to an embodiment of the present disclosure.

FIG. 4 is a perspective view of the flexible rotary cutting device of FIG. 1, according to an embodiment of the present disclosure.

FIG. 5 is a flow diagram illustrating a method of use for trimming vegetation, according to an embodiment of the present disclosure.

FIG. 6 is a front elevational view of an alternative embodiment of the present invention shown installed into a typical environment of a mower deck.

FIG. 7 is three-dimensional isometric view of a spacer element used in the embodiment thereof.

FIG. 8 is a partially exploded three-dimensional isometric view of the spacer element of FIG. 7 inserted into a cutting head element of the embodiment thereof.

FIG. 9 is a three-dimensional isometric view with an alternative embodiment spacer element.

FIG. 10 is a three-dimensional isometric view with another alternative embodiment spacer element.

FIG. 11 is a three-dimensional isometric view with another alternative embodiment spacer element.

FIG. 12 is a three-dimensional isometric view with another alternative embodiment spacer element.

FIG. 13 is a top plan view of a bottom enclosure of the cutting head element thereof.

FIG. 14 is a three-dimensional isometric view showing the cutting head element connecting with a mower deck.

FIG. 15 is a three-dimensional isometric view of an alternative embodiment cutting head element connecting to a rotary drive element of a mower deck environment.

FIG. 16 is a three-dimensional partially exploded isometric view thereof.

FIG. 17 is a detailed view of a cutting filament element interfacing with spring pawl elements of the embodiment thereof.

FIG. 18 is another detailed view thereof, showing the cutting filament advanced.

FIG. 19 is a partially exploded three-dimensional isometric view of the alternative embodiment of FIG. 15 with the spacer element of FIG. 8.

FIG. 20 is a three-dimensional isometric view of the embodiment of FIG. 15 with the spacer element of FIG. 9.

FIG. 21 is a three-dimensional isometric view of the embodiment of FIG. 15 with the spacer element of FIG. 10.

FIG. 22 is a three-dimensional isometric view of the embodiment of FIG. 15 with the spacer element of FIG. 11.

FIG. 23 is a three-dimensional isometric view of the embodiment of FIG. 15 with the spacer element of FIG. 12.

FIG. 24 is a top plan view of the bottom casing element of the embodiment of FIG. 15.

FIG. 25 is a three-dimensional isometric view of the embodiment of FIG. 15 shown assembled without cutting filament elements installed therein.

FIG. 26 is a three-dimensional isometric view of a slightly alternative embodiment thereof.

FIG. 27 is a three-dimensional isometric view of a three-tooth cam element thereof.

FIG. 28 is a side elevational view thereof.

FIG. 29 is a front elevational view thereof.

FIG. 30 is a rear elevational view thereof.

FIG. 31 is a top plan view of an alternative bottom enclosure of the cutting head element of the present invention with a filament in a first position.

FIG. 32 is a top plan view thereof with the filament thereof in a second position.

FIG. 33 is a top plan view thereof with the filament thereof in a third position.

### DETAILED DESCRIPTION

The various embodiments of the present invention will hereinafter be described in conjunction with the appended drawings, wherein like designations denote like elements.

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Cutting Head System 100

As discussed above, embodiments of the present disclosure relate to a lawnmower blade and more particularly to a flexible rotary cutting device and method as used to improve the trimming of vegetation.

Generally, the flexible rotary cutting device provides an attachment to replace fixed blades on all types of lawnmowers with a flexible cutting device. It offers a non-solid blade type for mowing both normal lawns and vegetation over rough and rocky terrain. It affords housing protection for mowing in rough areas to prevent damage to cutting device housing. This prevents the mower blades, including those on push mowers, self-propelled mowers or tractors, from damage. The flexible rotary cutting device reduces the risk of many accidents, hazards, and injuries associated with fixed lawnmower blades.

The flexible rotary cutting device includes a flexible cutting-filament that has sufficient rigidity to sever vegetation, but enough flexibility that the cutting-filament will not sever non-vegetation materials, such as rocks and wood. The housing of the cutting device is preferably constructed of metal with smooth, rounded edges to decrease friction and prevent injury or damage due to collisions with the housing. The device may utilize a variety of flexible cutting-filaments made of nylon, cable, wire, or other suitable material that provides uniform cutting with flexibility when making contact with solid objects, such as rocks, sticks, and other hazards. The attachment may be equipped with any type of commonly used blade attachment type, such as the circular or star-shaped apertures often used in commercial lawnmowers. Some embodiments may include aperture-adapters that may allow a single unit of the flexible rotary cutting device to be used with multiple types of lawnmowers. The cutting-filament can be replaced as needed by the user by simply threading the cutting-filament into the housing of the cutting device. A cutting-filament retention mechanism within the housing allows the cutting-filament to be inserted inwards, but prevents the cutting-filament from moving outwards from the housing, thereby resisting centrifugal forces when the housing is spun at high speed. In this way, the cutting-filament may be reliably retained during use and yet easily replaced when the cutting-filament has been expended.

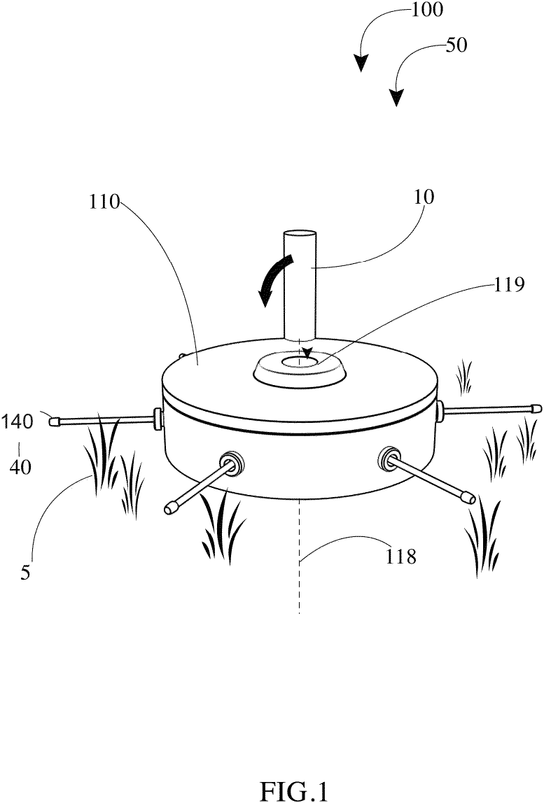

Referring now more specifically to the drawings by numerals of reference, there is shown in FIGS. 1-4, various views of a cutting device 100.

FIG. 1 shows a cutting device 100 during an ‘in-use’ condition 50, according to an embodiment of the present disclosure. Here, cutting device 100 may be beneficial for use by a user 40 to trim vegetation 5. As illustrated, cutting device 100 may be attachable to rotary drive 10, being configured to trim vegetation 5. Attachment mechanism 119 may be affixed to cutting head 110, attachment mechanism 119 enabling cutting head 110 to be releasably attached to rotary drive 10. Attachment mechanism 119 may comprise an aperture configured to receive and circumscribe rotary drive 10. Rotational axis 118 may pass through the center of disk 112, cutting head 110 and rotary drive 10 being rotatable about rotational axis 118 when in use. Upon reading this specification, it should be appreciated that, under appropriate circumstances, considering such issues as user preferences, design preference, structural requirements, marketing preferences, cost, available materials, technological advances, etc., other structural arrangements such as, for example, alternative cutting-filament orientations, cover attachment means, manufacturing methods, etc., may be sufficient.

According to one embodiment, the cutting device 100 may be arranged as a kit 105. In particular, the cutting device 100 may further include a set of instructions 107. The instructions 107 may detail functional relationships in relation to the structure of the cutting device 100 such that the cutting device 100 can be used, maintained, or the like, in a preferred manner.

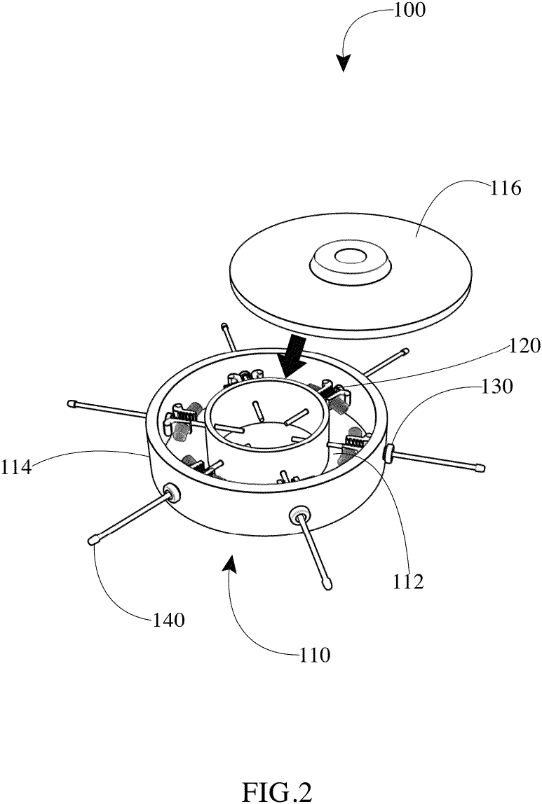

FIG. 2 shows cutting device 100 of FIG. 1, according to an embodiment of the present disclosure. Cutting device 100 may include cutting head 110, at least one cutting-filament retention mechanism 120, at least one filament aperture 130, and at least one cutting-filament 140. Cutting head 110 may include disk 112, outer flange 114, cover 116. Outer flange 114 may be affixed to disk 112, outer flange 114 defining a cylindrical inner volume. Cover 116 may be affixed to outer flange 114, and may be concentric to disk 112. Cover 116 of cutting head 110 may be affixed to disk 112 of cutting head 110 via threaded fasteners. Disk 112 of cutting head 110, outer flange 114 of cutting head 110, and cover 116 of cutting head 110 may be joined with rounded seams. Cutting head 110 may be constructed of metal. At least one cutting-filament retention mechanism 120 may be affixed to cutting head 110. Six of at least one filament retention mechanism(s) may be disposed within cutting head 110, each of at least one filament retention mechanism 120 each being separated by sixty degrees. At least one filament-aperture 130 may be disposed within outer flange 114 of cutting head 110. At least one cutting-filament 140 may be releasably attached to at least one cutting-filament retention mechanism 120, at least one cutting-filament 140 being configured to sever vegetation 5 as cutting head 110 is rotated. At least one cutting-filament 140 may be passed through at least one filament-aperture 130, and between first-filament engaging pawl 126 and second-filament engaging pawl 126, such that at least one cutting-filament 140 extends radially from outer flange 114 of cutting head 110 when attached to at least one cutting-filament retention mechanism 120.

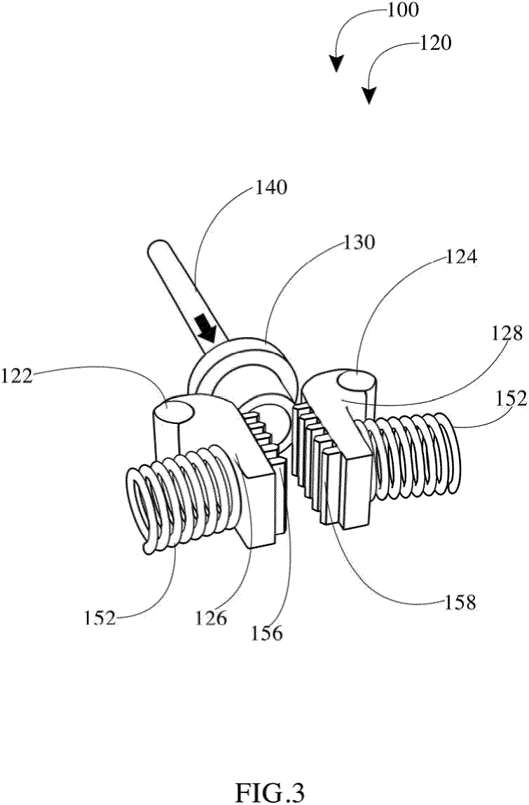

FIG. 3 is a perspective views of cutting device 100 of FIG. 1, according to an embodiment of the present disclosure. At least one cutting-filament retention mechanism 120 may include first-fulcrum cylinder 122, second-fulcrum cylinder 124, first-filament engaging pawl 126, and second-filament engaging pawl 128. First-fulcrum cylinder 122 may have a first-fulcrum axis affixed to cutting head 110, and second-fulcrum cylinder 124 may likewise be affixed to cutting head 110. First-filament engaging pawl 126 may pivotably engage first-fulcrum cylinder 122 and may further include first-plurality of teeth 156. Likewise, second-filament engaging pawl 128 may pivotably engage second-fulcrum cylinder 124, and may have second-plurality of teeth 158, second-filament engaging pawl 128 mirroring first-filament engaging pawl 126. At least one cutting-filament 140 may be engaged and anchored by first-plurality of teeth 156 and second-plurality of teeth 158. At least one cutting-filament 140 may be releasably attached to at least one cutting-filament retention mechanism 120, at least one cutting-filament 140 being passed through at least one filament-aperture 130, and between first-filament engaging pawl 126 and second-filament engaging pawl 128, such that at least one cutting-filament 140 is engaged and anchored by first-plurality of teeth 156 and second-plurality of teeth 158, such that at least one cutting-filament 140 extends radially from outer flange 114 of cutting head 110. First-plurality of teeth 156 of first-filament engaging pawl 126 and second-plurality of teeth 158 of the second-filament engaging pawl 128 may each include five of said teeth. At least one cutting-filament retention mechanism 120 may further includes at least one pawl-spring engaging first-filament engaging pawl 126 and second-filament engaging pawl 128, at least one pawl-spring 152 being configured to push first-filament engaging pawl 126 and second-filament engaging pawl 128 into engagement towards each other. At least one pawl-spring 152 may comprise at least one coil spring.

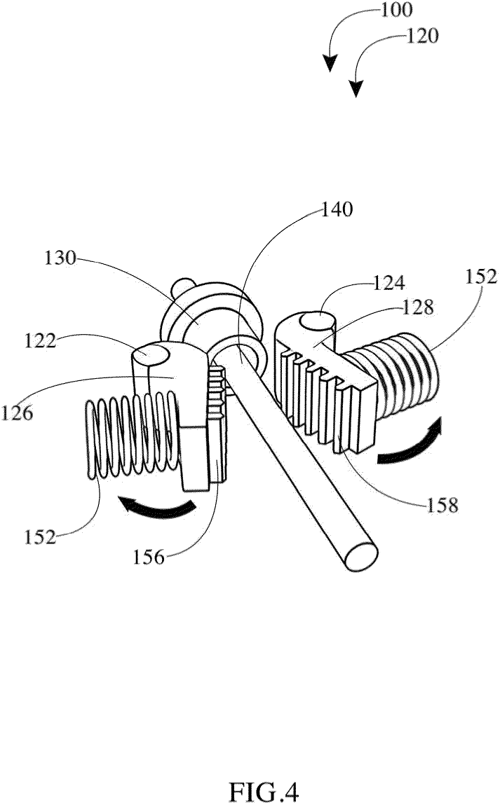

Referring now to FIG. 4 showing a perspective views of cutting device 100 of FIG. 1, according to an embodiment of the present disclosure. As before, at least one cutting-filament retention mechanism 120 may include first-fulcrum cylinder 122, second-fulcrum cylinder 124, first-filament engaging pawl 126, and second-filament engaging pawl 128. At least one pawl-spring 152 is further configured to push first-filament engaging pawl 128 and second-filament engaging pawl 126 into engagement with at least one cutting-filament 140 when at least one cutting-filament 140 is passed between first-filament engaging pawl 126 and second-filament engaging pawl 128. First-plurality of teeth 156 of first-filament engaging pawl 128 mirrors second-plurality of teeth 158 of second-filament engaging pawl 128, first-plurality of teeth 156 of first-filament engaging pawl 126 and second-plurality of teeth 158 of second-filament engaging pawl 126 being disposed towards each other, such that first-plurality of teeth 156 of first-filament engaging pawl 128 and second-plurality of teeth 158 of second-filament engaging pawl 126 engage at least one cutting-filament 140 when at least one cutting-filament 140 is releasably attached to at least one cutting-filament retention mechanism 120.

First-plurality of teeth 156 of first-filament engaging pawl 126 and second-plurality of teeth 158 of second-filament engaging pawl 128 may be angled in a radially outward direction with respect to disk 112 of cutting head 110, first-plurality of teeth 156 of first-filament engaging pawl 126 and second-plurality of teeth 158 of second-filament engaging pawl 128 being configured to resist movement of at least one cutting-filament 140 only in a radially outward direction. Additionally, first-filament engaging pawl 126 and second-filament engaging pawl 128 are pointed away from first-fulcrum cylinder 122 and second-fulcrum cylinder 124 in a radially inward direction with respect to disk 112 of cutting head 110, such that first-filament engaging pawl 126 and second-filament engaging pawl 128 are able to pivot away from each other when at least one cutting-filament 140 is pushed between them from a radially outward direction with respect to disk 112 of cutting head 110, first-plurality of teeth 156 of first-filament engaging pawl 126 and second-plurality of teeth 158 of the second-filament engaging pawl 128 being configured to resist movement of at least one cutting-filament 140 only in said radially outward direction.

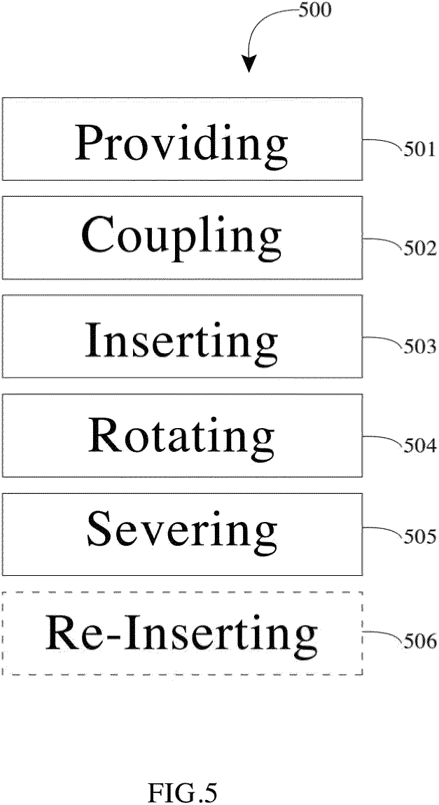

FIG. 5 is a flow diagram illustrating a method for trimming vegetation 500, according to an embodiment of the present disclosure. In particular, the method for trimming vegetation 500 may include one or more components or features of the cutting device 100 as described above. As illustrated, the method for trimming vegetation 500 may include the steps of: step one 501, providing a cutting device attachable to a rotary drive configured to trim vegetation as disclosed; step two 502, coupling the attachment mechanism to the rotary drive; step three 503, inserting the at least one cutting-filament into the at least one cutting-filament retention mechanism; step four 504, rotating the rotary drive in order to rotate the cutting device in tandem with the rotary drive; step five 505, severing vegetation with the at least one cutting-filament as the at least one cutting-filament makes contact with vegetation; and optionally, step six 506, re-inserting the at least one cutting-filament into the at least one cutting-filament retention mechanism as the at least one cutting-filament is consumed.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods and means for trimming vegetation, are taught herein.

### III. Alternative Embodiment Cutting Head System 602

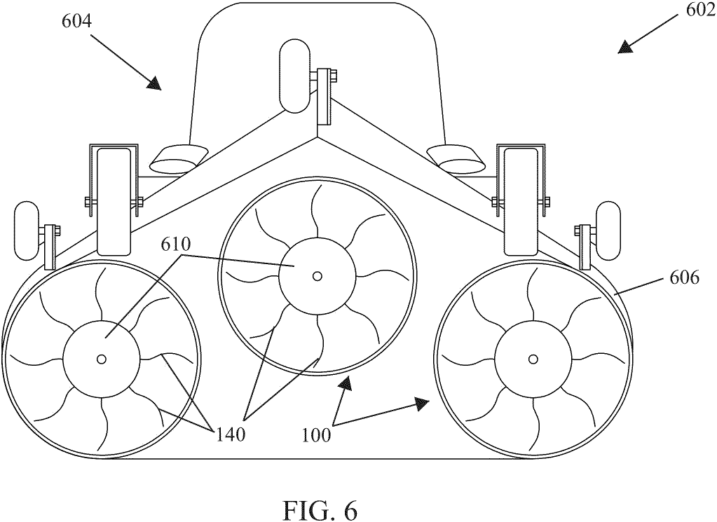

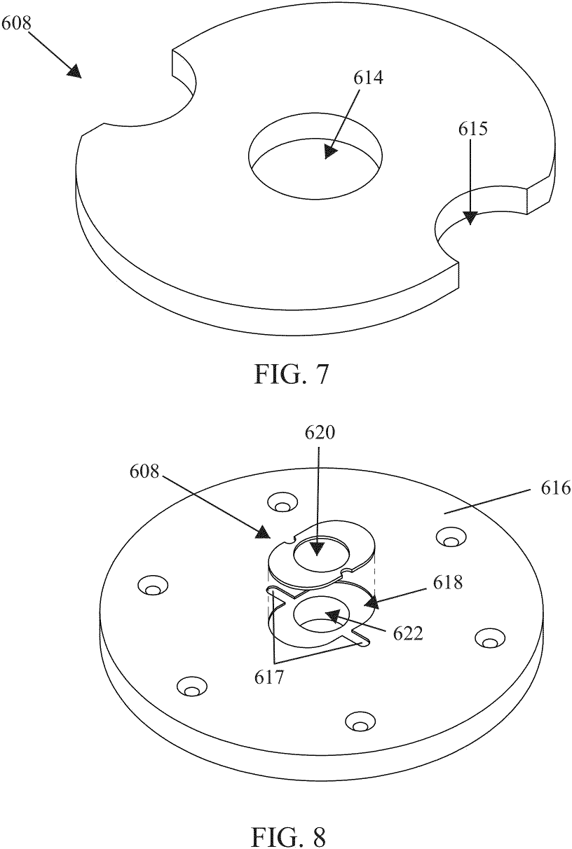

FIG. 6 shows a slightly alternative embodiment of the present invention lawnmower cutting system 602 which shows in more detail how the cutting device 100 integrates with a lawn mower 604 deck 606. As shown, multiple of the cutting devices 100 can replace traditional lawn mower blades, using the cutting filaments 140 as the cutting source. FIGS. 7 - 14 also show slightly modified cutting heads 610 which use various spacers to integrate with most existing lawn mowers.

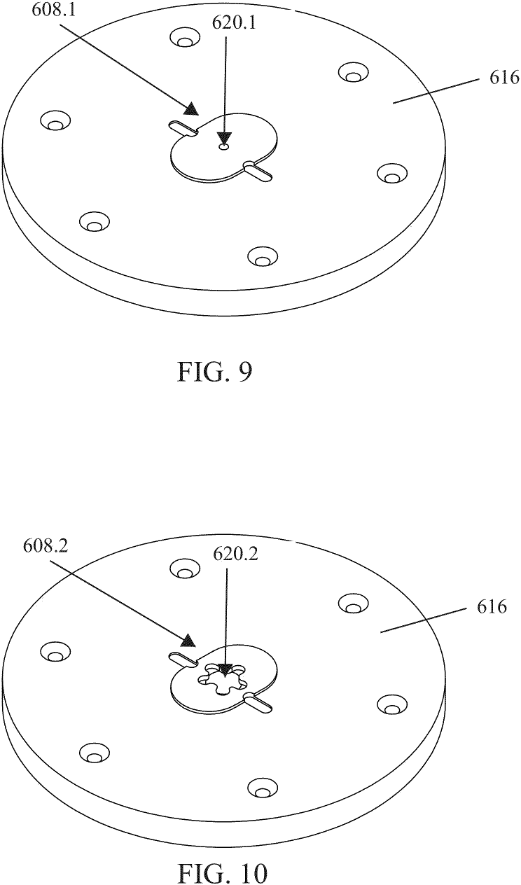

FIG. 7 shows such a spacer 608 which can be placed, either temporarily or permanently, into the cover 616 of the cutting head 610 as shown in FIG. 8. A central receiver 620 connects to the rotary drive 10 of the lawn mower 604. It lines up over the receiver 622 of the cutting head 610 cover 616. A pair of surface reliefs 617 extend from a central relief 618, the pair of surface reliefs 617 line up with the edge reliefs 615 on the spacer, which allows for easy alignment and removal of the spacer with the cover 616. FIGS. 9 - 12 show alternative spacers 608.1, 608.2, 608.3, 608.4 having alternative receiver shapes 620.1, 620.2, 620.3, 620.4 for connection to different lawn mower rotary drive 10 types.

FIG. 13 shows a base 612 of the cutting head 610 which provides alternative spring pawls 624 located on rotation points 626 to secure the cutting filament 140 within the reliefs 628 which allow the filaments to extend out from the cutting head 610.

### IV. Alternative Embodiment Cutting Head System 702

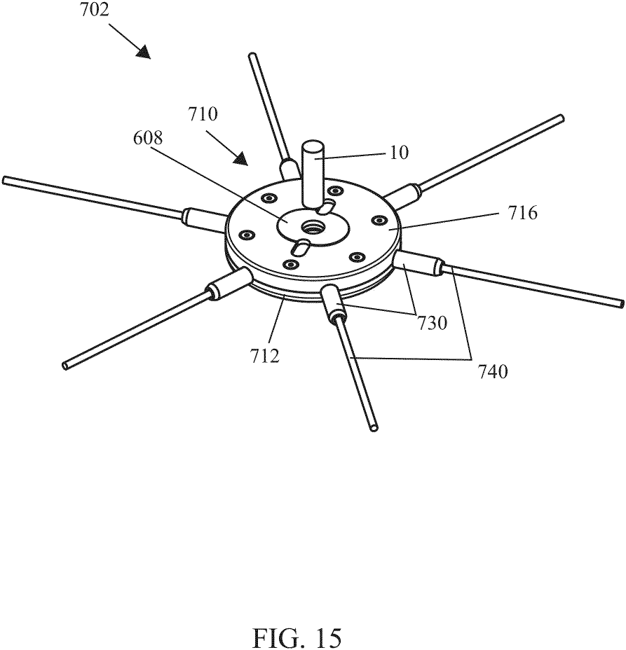

FIGS. 15 - 23 show another alternative embodiment cutting head system 702, similar to that of the embodiment 602 disclosed above and including several of the same elements thereof. The cutting head system 702 includes a cutting head 710 with a top 716 and bottom 712 portion. Several cutting head apertures 730 are installed between the top 716 and bottom 712 portions of the cutting head 710. Cutting filaments 740 are inserted into a respective aperture 730. The cutting head 710 is connected to the rotary drive 10 of a mower deck. The spacer 608 disclosed above is used to ensure proper connection to the rotary drive 10.

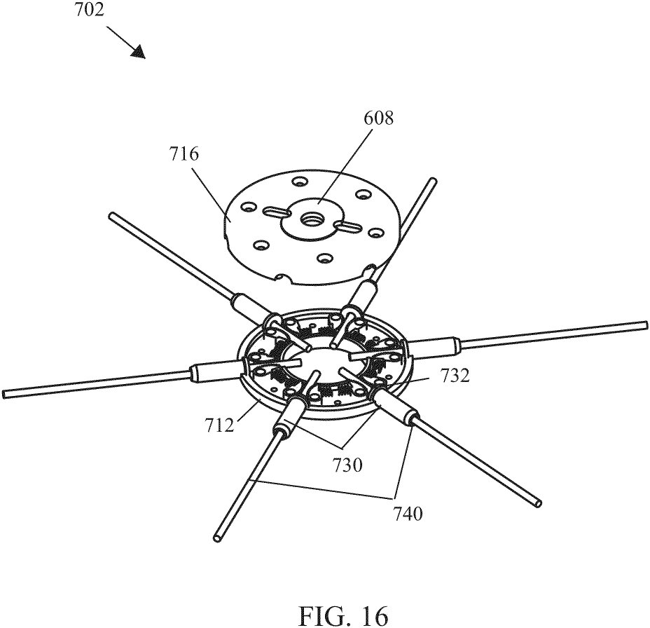

FIG. 16 shows how the filaments 730 are retained within the cutting head 710 between the upper 716 and lower 712 portions using a connecter end 732 to retain the aperture within the cutting head.

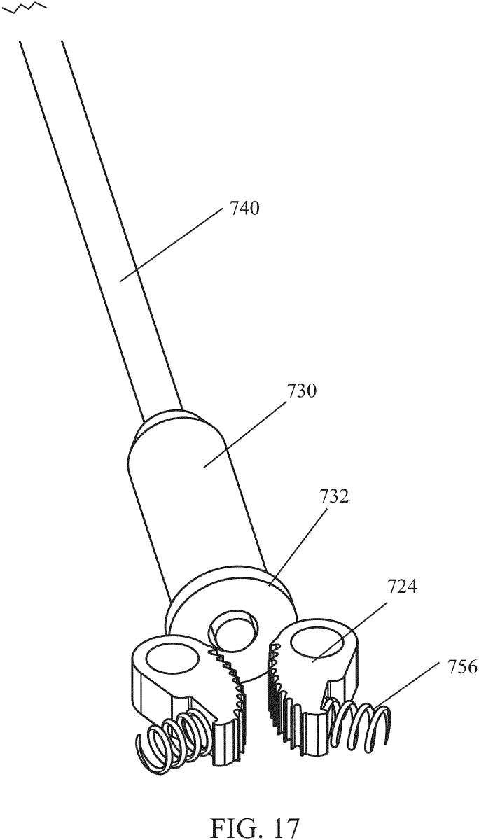

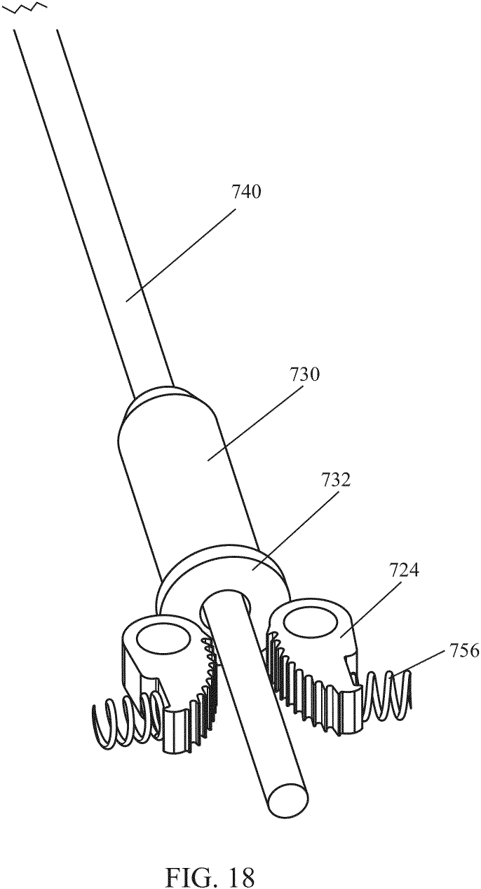

FIGS. 17 and 18 show how the cutting filament 740 is inserted through the aperture 730 and out the end connector 732 into a spring pawl 724 with spring 756 for gripping and retaining the filament 740 within the cutting head.

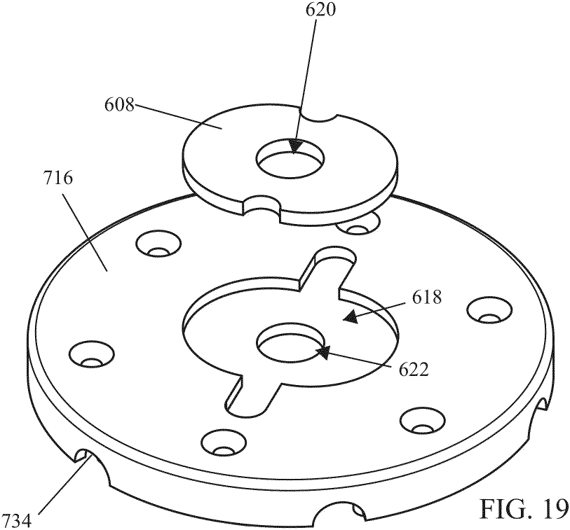

FIG. 19 shows one embodiment of a top portion 716 of the cutting head with the spacer 608 of FIG. 8 including a receiver 620 for receiving one type of rotary drive 10. Aperture receivers 734 receive the apertures as shown above.

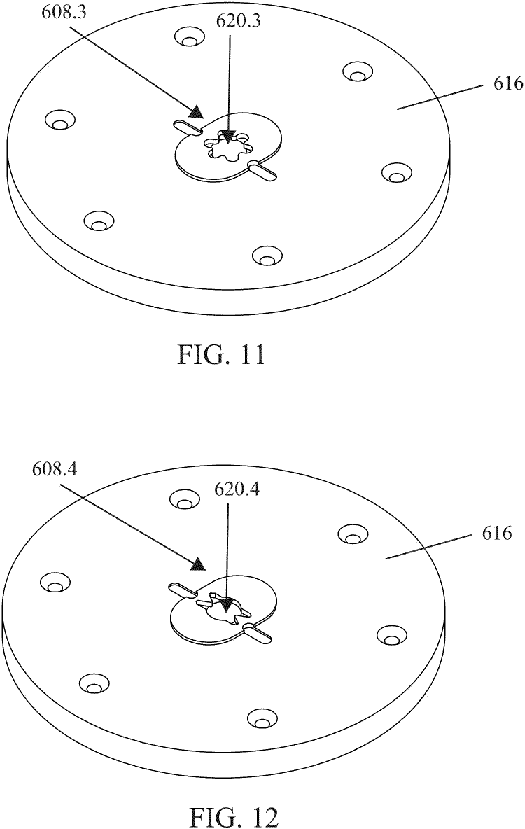

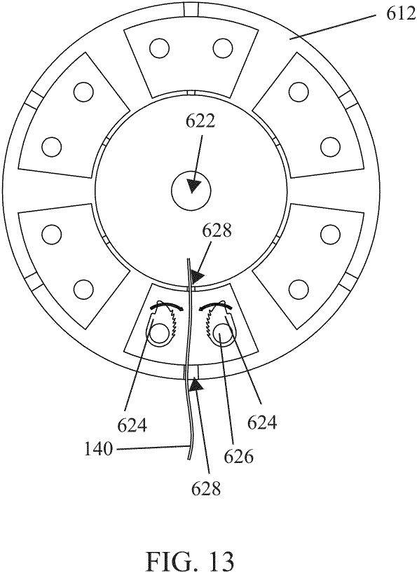

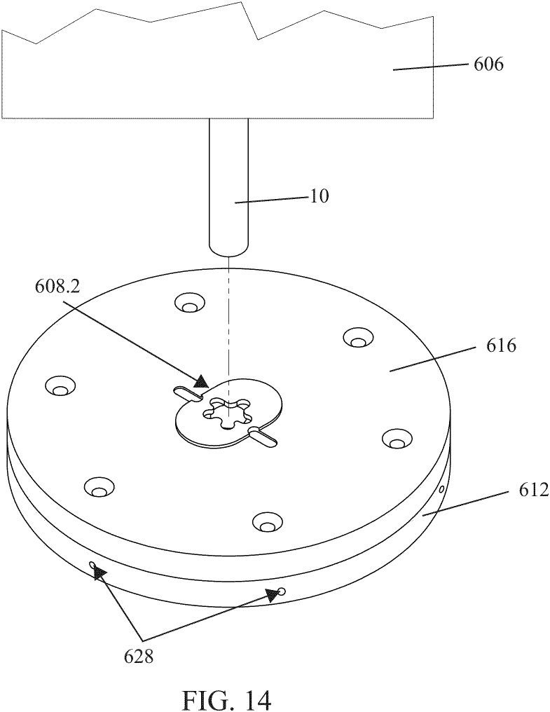

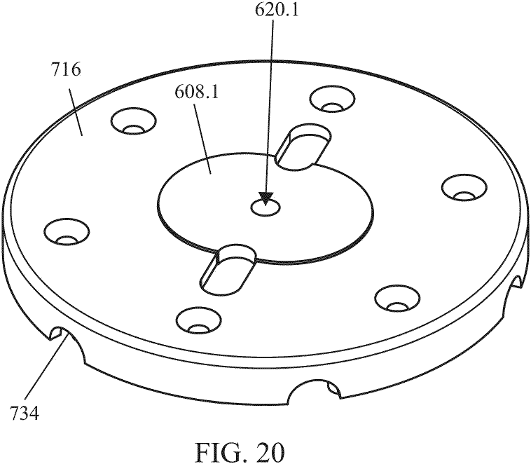

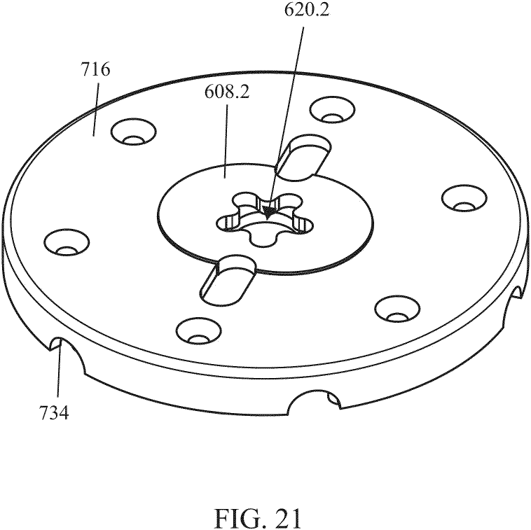

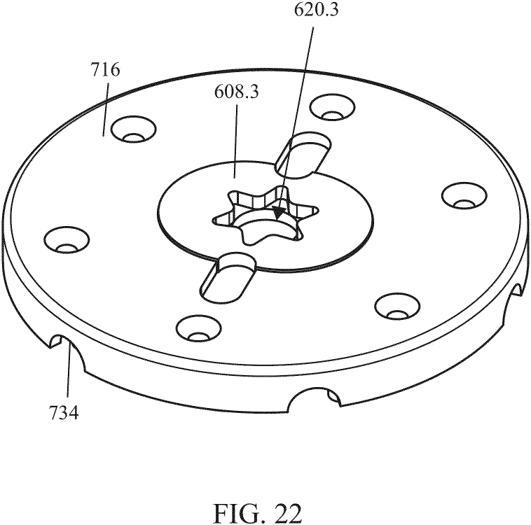

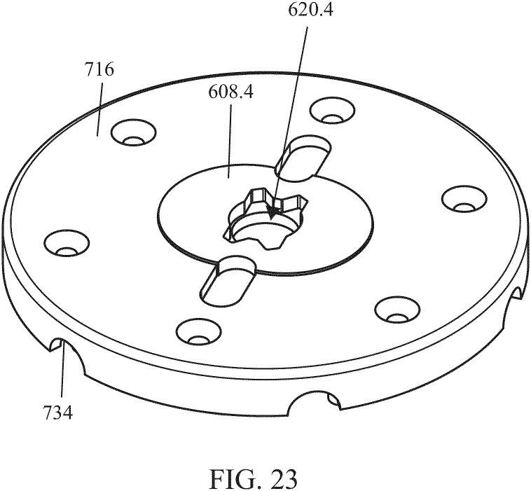

Similarly, FIG. 20 shows the spacer 608.1 of FIG. 9, including receiver 620.1. FIG. 21 shows the spacer 608.2 of FIG. 10, including receiver 620.2. FIG. 22 shows the spacer 608.3 of FIG. 11, including receiver 620.3. FIG. 23 shows the spacer 608.4 of FIG. 12, including receiver 620.4.

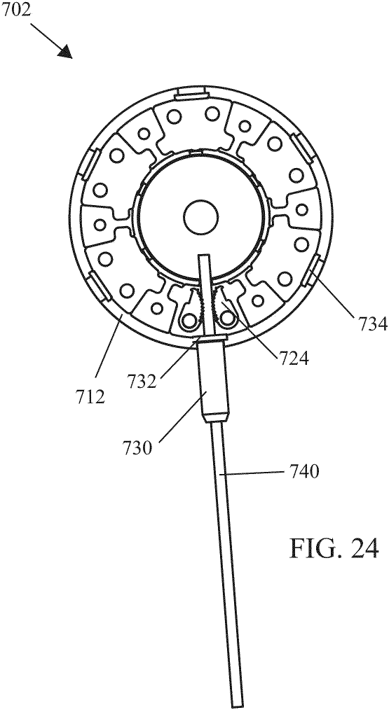

FIG. 24 is a top plan view showing the aperture 730 received within the bottom portion 712 of the cutting head retaining the aperture 730 connector 732 within the housing itself. The cutting filament 740 is inserted through the aperture and received by the spring pawls 724.

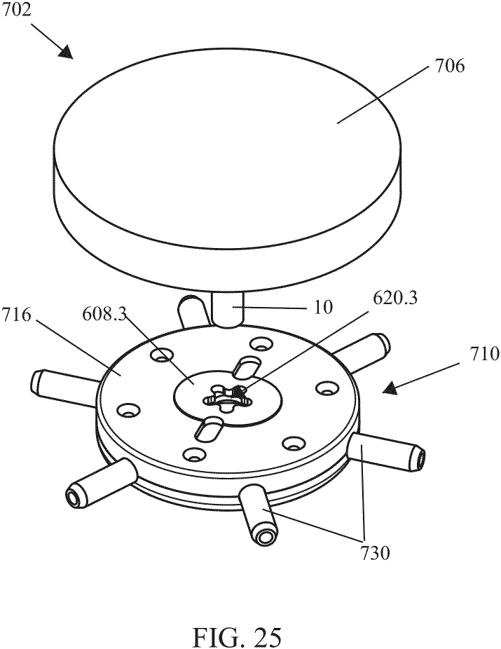

FIG. 25, like FIG. 15, shows the assembly of the cutting head 710 with the apertures 730 installed and connecting to the rotary drive 10 of a mower 706.

### V. Alternative Embodiment Cutting Head System 802 With Three-Tooth Cam 852

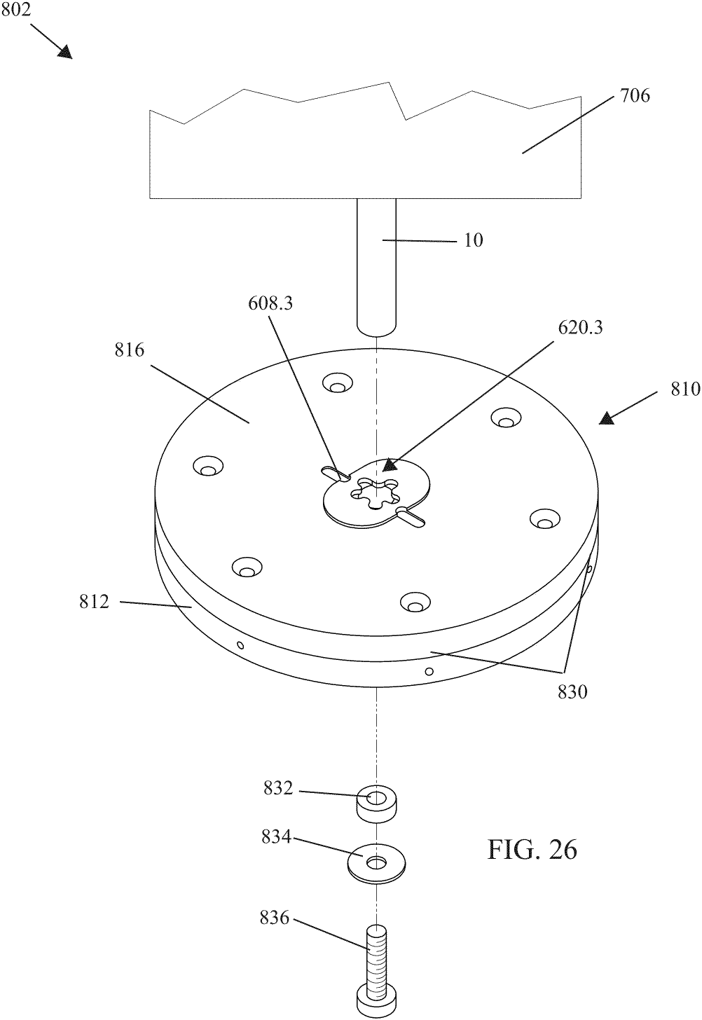

FIG. 26, like FIG. 25, shows the assembly of a cutting head 810 with the apertures 830 appearing as no more than small holes on the side of the cutting head 810 assembly formed by the top 816 and bottom 812 halves. Here, shown with alternative receiver spacer 608.3 with shape 620.3 as an example, the spacer is inserted into the relief of the top 816 half of the cutting head 810 and is again shown connecting to the rotary drive 10 of a mower 706. On the bottom, connecting the two halves 812, 816 of the cutting head 810 to the rotary drive 10 is shown a mounting bolt 836 passing through a washer 834 and bushing 832. The Bushing 832 decreases the hole size, thus allowing the cutting head assembly 810 to even be used on pushing mowers.

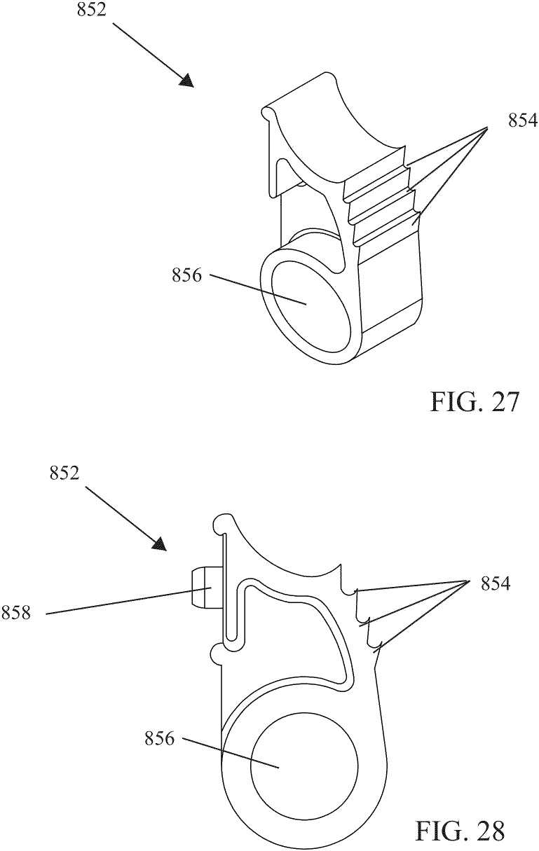

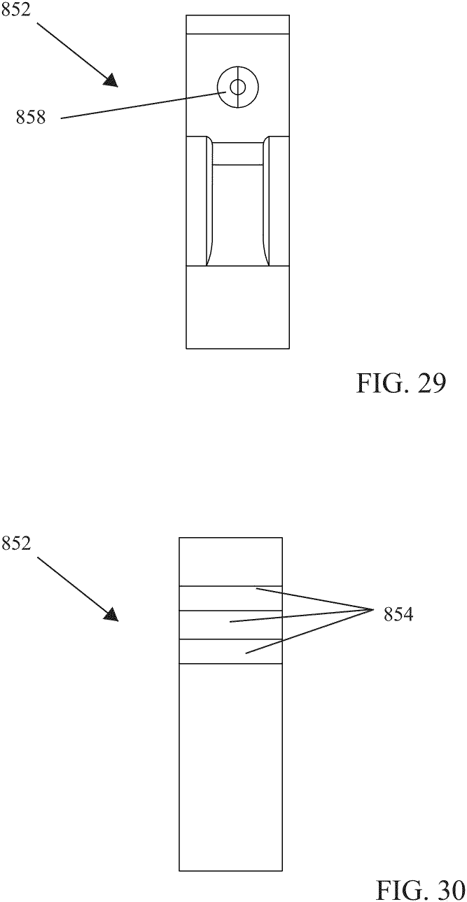

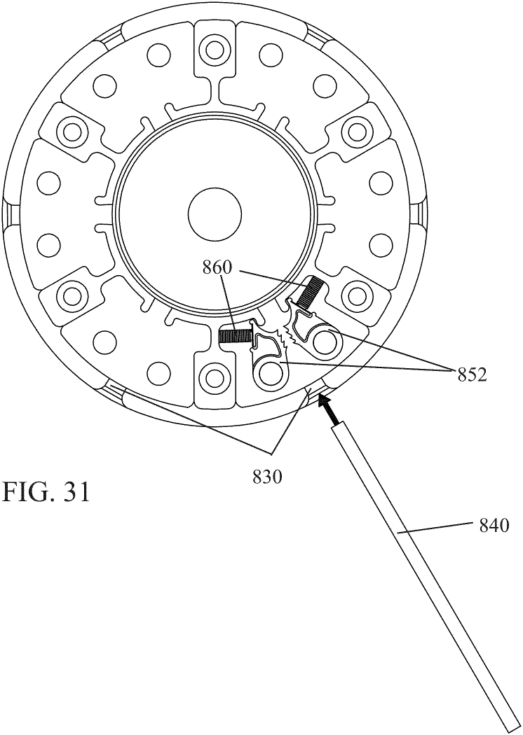

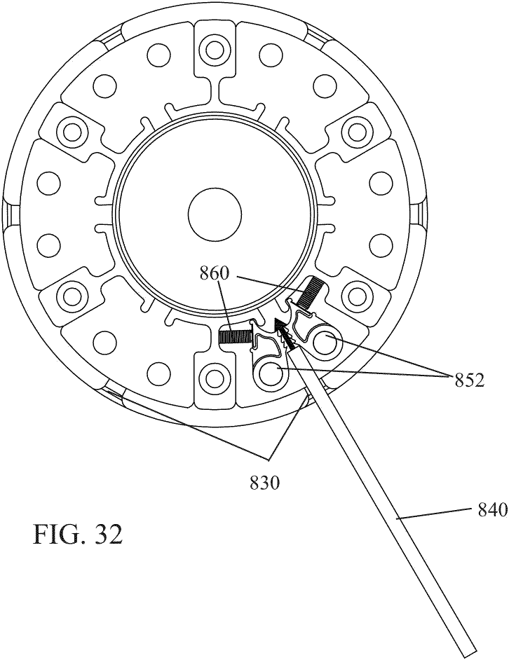

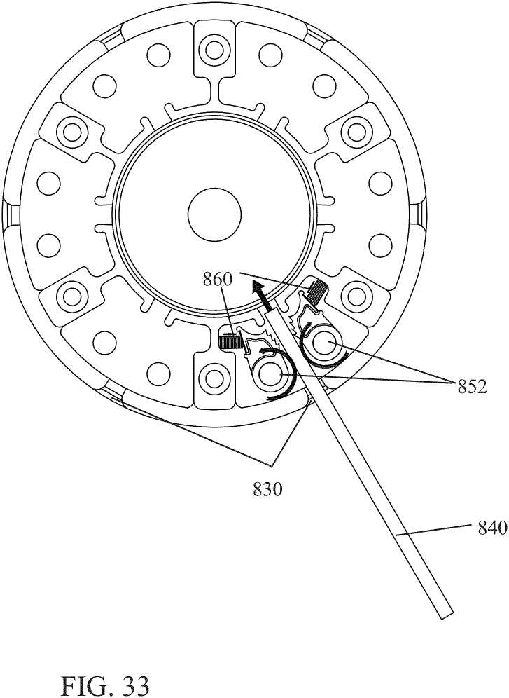

FIGS. 27-30 show a three-toothed cam 852. The main feature are the three teeth 854 on the rear face of the cam and the fulcrum cylinder 856 around which the cam 852 spins when pushed. A spring receiver 858 connects to springs 860 which are placed within the bottom plate 812 of the cutting head 810. As shown in FIGS. 31-33, the apertures 830 allow a stick-shaped filament 840 to be pushed through the aperture, through the teeth 854 of the cams, thereby pushing against the springs 860 and eventually locking the filament in place between the cams 852 due to the spring 860 forces. The spinning force of the cutting head will not dislodge the filament 840 from the cams 852. However, when worn down, the user can simply pull on the remaining end of the filament 840 and it will easily be removed, returning the cams 852 to their original positions shown in FIG. 31 due to the spring 860 forces.

The cutting head 710 could be manufactured using 3D printing technology using a nylon material. This would allow use with smaller electric lawn mowing machines wherein the lighter weight material would increase the battery life and enhance the usability of the electric lawn mowing machine. The nylon material is structurally sound enough to remain in place in such an embodiment.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A cutting head system comprising:
a cutting head comprising a disk having a top cover portion and a bottom cover portion and a rotational axis passing through the center of said cutting head;
a receiver for receiving and attaching to a rotary drive of a commercial lawn mowing machine;
a central relief within a top face of said top cover portion;
a removable spacer placed within said central relief of said top cover portion of said cutting head, said removable spacer configured to a connecting end of said rotary drive;
said central relief including grooves configured to provide grip against said removable spacer;
at least one cutting filament retention mechanism comprising a first fulcrum cylinder having a first fulcrum axis affixed to the cutting head, the first fulcrum axis being parallel but not concentric to the rotational axis, a second fulcrum cylinder having a second fulcrum axis affixed to the cutting head, the second-fulcrum axis being parallel but not concentric to the rotational axis, a first filament engaging cam pivotably engaging the first fulcrum cylinder, and a second filament engaging cam pivotably engaging the second-fulcrum cylinder, the second filament engaging cam mirroring the first filament engaging cam;
each of said first filament engaging cam and said second filament engagement cam comprising three teeth configured for engaging said filament;
each of said first filament engaging cam ad said second filament engaging cam comprising a spring receiver configured for being inserted into an securing a first end of a respective first spring and second spring;
a second end of said first spring connected to a first interior face of said bottom cover portion;
a second end of said second spring connected to a second interior face of said bottom cover portion;
a filament aperture disposed within said cutting head within an aperture receive defined by said top cover portion and said bottom cover portion;
a cutting filament, said at least one cutting filament having a straight body, a proximal end, and a distal end;
said proximal end of said cutting filament configured to be inserted through one of said filament aperture such that said cutting filament pushes past said three teeth of each respective one of said first filament engaging cam and said second filament engaging cam, thereby forcing said first filament engaging cam to rotate counter-clockwise about said first fulcrum cylinder and said second filament engaging cam to rotate clockwise about said second fulcrum cylinder, and thereby depressing said first spring and said second spring;
wherein said cutting filament is configured to remain engaged with said first filament engaging cam and said second filament engaging cam due to said first and second springs; and
wherein a user may selectively remove said cutting filament from said filament aperture by pulling said distal end of said cutting filament away from said filament aperture.

2. The system of claim 1, wherein said spacer comprises a star-shaped opening.

3. The system of claim 1, wherein said spacer comprises a circular opening.

4. The system of claim 3, wherein said circular opening further comprises a plurality of notches.

5. The system of claim 1, further comprising:
a bushing configured to reduce a diameter of said receiver;
said rotary drive belonging to a push-action lawn mowing machine; and
thereby allowing said rotary drive to fit within said receiver via said bushing.

6. A lawn mower cutting head system comprising:
a cutting head assembly comprising a cylindrical housing having a top portion and a bottom portion and a rotational axis passing through a center of said cutting head assembly;
six aperture receivers spaced equally around said cutting head assembly within said top and bottom portions;
a central relief located within a top face of said top portion of said housing;
a removable spacer placed within said central relief of said top cover portion of said cutting head, said removable spacer configured to be connected to an end of said rotary drive of a commercial lawn mowing machine;
said removable spacer comprising a pair of edge reliefs;
said removable spacer selected from a set of removable spacers, a distinctly shaped central relief passing through a center of each respective one of said plurality of removable spacers such that each one of said plurality of removable spacers, said removable spacer selected and adapted according to a cross-sectional shape for a particular type of rotary drive;
said central relief including a pair of surface reliefs extending away from said central relief, said pair of surface reliefs configured to align with said pair of edge reliefs of said removable spacer, and said surface reliefs further configured to provide grip against said removable spacer via said edge reliefs;
six apertures each inserted into a respective one of said six aperture receivers, each one of said six apertures comprising a body and an end, wherein each said end is a larger diameter than each respective body thereof, and wherein each said end is configured to retain said aperture within said respective one of said six aperture receivers;
six pairs of cams each installed adjacent to a respective one of said six apertures, each of said six pairs of cams comprising springs engaging said cams via a spring receiver inserted through a first end of the respective spring, and each one of said six pairs of cams installed onto a respective fulcrum cylinder about which each respective cam may turn;
six cutting filaments each comprising a straight body having a proximal end and a distal end;
each of said six cutting filaments inserted into a respective one of said six apertures via their respective proximal ends and engaged with a respective one of said six pairs of cams, said springs pressing said respective one of said six pairs of cams against the respective one of said six cutting filaments;
each cam of said six pairs of cams comprising three teeth configured for engaging and retaining a respective one of said six cutting filaments; and
whereby each of said six cutting filaments is selectively removable from their respective apertures by pulling against their respective proximal ends.

7. The system of claim 6, wherein said cutting head assembly replaces an existing lawn mower blade within said commercial lawn mowing machine.

8. A method of implementing a replacement cutting head within a commercial lawn mowing machine, said commercial lawn mowing machine initially comprising a lawn mower blade and a rotary drive, the method comprising the steps:
removing the lawn mower blade from the lawn mowing machine;
providing a cutting head assembly comprising a cylindrical housing having a top portion and a bottom portion and a rotational axis passing through a center of said cutting head assembly;
selecting a spacer from a set of removable spacers, and placing said spacer within a central relief located on a top face of said top portion of said cylindrical housing, said spacer selected from said set of removable spacers according to a cross-sectional shape of said rotary drive such as to interface with the rotary drive of the lawn mowing machine;
wherein said spacer comprises a pair of edge reliefs;
wherein said central relief includes a pair of surface reliefs extending away from said central relief, said pair of surface reliefs configured to align with said pair of edge reliefs of said spacer, and said surface reliefs further configured to provide grip against said spacer via said edge reliefs;
connecting said cutting head assembly to said rotary drive;
inserting a plurality of cutting filaments into a corresponding and respective number of apertures retained within said cylindrical housing;
retaining each respective one of said plurality of cutting filaments within a respective pair of pawls, each pawl comprising a plurality of gripping teeth configured to grasp and retain said respective one of said plurality of cutting filaments within the corresponding respective aperture;
each said pawl engaging a spring, each said spring configured to press each respective said pawl against a respective one of said plurality of cutting filaments;
operating said lawn mowing machine;
cutting vegetation with said cutting filaments;
removing at least one of said plurality of cutting filaments; and
replacing said at least one of said plurality of cutting filaments.

9. The method of claim 8, further comprising the steps:
engaging each respective one pawl of said plurality of pair of pawls about a respective pair of fulcrum cylinders such that each said respective one pawl is rotatable about its respective fulcrum cylinder.
